(19) United States
(12) Patent Application Publication
(10) Pub. No.: US 2007/0212673 A1
(43) Pub. Date: Sep. 13, 2007

(54) System and method for providing continuing education

(76) Inventor: Edward C.J. King, London (GB)

Correspondence Address: WINSTON & STRAWN LLP;PATENT DEPARTMENT, 1700 K STREET, N.W., WASHINGTON, DC, 20006, US

(21) Appl. No.: 11/369,954

(22) Filed: Mar. 8, 2006

(51) Int. Cl. G09B 3/00

(52) U.S. Cl. 434/350

(57) ABSTRACT

A system and method for providing continuing education programs for professionals, particularly healthcare professionals, that includes connecting a plurality of users with an expert in a first community via a network, facilitating the interactive communication of educational material related to at least one educational topic, and making the interactive communication available for assessment of the value to permit future modification of educational materials associated therewith. Preferably, the system and method further include assessing the interactive communication, adapting the educational material, and distributing the educational material to at least a second community.

### FIELD OF THE INVENTION

The invention relates to a system and method for providing an interactive educational model for continuing education, preferably continuing medical education.

### BACKGROUND OF THE INVENTION

Many professions, such as law and medicine, require and/or encourage their professionals to remain current with advances in the profession. Accordingly, these professions typically institute mandatory or recommended continuing education programs (commonly referred to as “courses,” “classes,” or “continuing education”). In the healthcare profession, in particular, licensed professionals, such as physicians, nurses, pharmacists, physicians' assistants, nurse practitioners, researchers, physical therapists, and certain healthcare executives (collectively known herein as “healthcare professionals”), for example, are typically required to earn continuing medical education (CME) credits in order to maintain their licensure or employment. The general purpose of such requirements is to provide some level of assurance that healthcare professionals are current in their medical knowledge.

Despite these requirements, it appears that traditional continuing education does not meet the needs of its professionals. For example, in healthcare, it is estimated that between 44,000 to 98,000 Americans in hospitals die every year as a result of medical errors, medical errors which may have been prevented by better training of healthcare professionals. These statistics suggest that either healthcare professionals do not have the skills needed, are not learning or remembering these skills, or simply that the needed skills are not being taught to them. In any case, traditional continuing medical education needs improvement to address the current problems in each profession, to identify gaps in the knowledge of new science or state-of-the-art treatment options, and to generally increase the aptitude of each professional.

Conventional continuing education programs are deficient in a number of areas. For example, continuing education programs typically do not provide an interactive forum in which training by a traditional, lecture-style teacher is supplemented by training through peers learning from one another (commonly referred to as “peer-to-peer” learning). That is, there are no continuing educational programs in which users participate in peer-to-peer learning, while also being able to access, as well as obtain guidance and advice from, an expert in the field who provides the more traditional role of a classroom teacher.

In conventional continuing education programs, it is common to find either a peer network or a traditional lecture-style education. For instance, on the one hand, healthcare professional “chat rooms,” such as Medscape's Forums, and discussion groups hosted on Internet portals, including groups provided by Yahoo! and Google, healthcare professionals interact with one another in a group setting. These rooms/groups offer peer-to-peer learning.

On the other hand, some continuing educational programs provide the opposite—a strictly traditional, classroom setting, in which a teacher provides instruction to one or more students. In certain forums, such as Medscape's “Ask the Experts,” users may interact with a teacher-like authority, asking questions and receiving a corresponding answer.

Traditional continuing education is also viewed by some healthcare and other professionals as stagnant and unresponsive, particularly as being non-adaptive and therefore not meeting the changing needs of the profession. In the healthcare field, for example, traditional continuing education programs generally do not address frequent, recurring, and/or new clinical issues. It would be beneficial to provide clinicians, for example, with answers or advice to assist day-to-day issues, particularly those issues which many clinicians have trouble resolving.

Conventionally, continuing education programs have rigorous syllabi, conforming the course substance of the course and prohibiting the course from covering ad hoc topics raised in-class by either the enrolled healthcare professionals or even the expert supervising the class. There is no conventional mechanism to identify the most significant issues raised by the professionals or expert and to adapt a curriculum that addresses these issues. Accordingly, without this adaptability, there is no systematic or comprehensive conventional mechanism to recognize significant new issues in one sub-discipline of a profession, and to determine whether those issues are relevant and/or important to other sub-disciplines.

Traditionally, in the healthcare profession, with the limitations of conventional continuing education programs to provide new or useful clinical information, becoming familiar with the newest or latest issues in the profession was necessarily a time-intensive, sporadic, and/or informal process. For example, healthcare professionals have typically relied on often clinically non-instructive, perhaps unverifiable sources of information, such as literature searches, presentations by researchers at formal medical conferences, and even simple polling of other healthcare professionals.

A more dynamic continuing education system and methods for providing continuing education of professionals is needed, particularly for healthcare professionals in continuing medical education. More specifically, continuing medical education needs a systematic approach designed to continually identify gaps in knowledge among healthcare professionals, to create medical educational programs to fill those gaps, and to facilitate better clinical and/or patient care. Accordingly, there is an unmet need in the art to identify the most common and/or pressing needs of professionals in continuing education, adapt those needs to further educational materials and follow up education, particularly to other disciplines within each profession. Additionally, there is an unmet need in the art to develop a system and method for interactive learning for a community that provides community members with current and responsive education that is further adaptable to other communities.

### SUMMARY OF THE INVENTION

The present invention meets the unmet needs in the art by providing a system and method for providing continuing education, preferably for continuing medical education, that allows users to exchange ideas among peers and with a designated expert in the community additionally interacting and providing input. Preferably, the present invention also provides a method to evaluate the content and scope of content in such continuing education exchanges to evolve content that is more relevant to the community and to adapt educational material for further distribution to the same or different communities, typically in the same profession. More preferably, the present invention provides a systematic approach to continuing medical education that is designed to continually identify gaps in knowledge among a healthcare community and to create responsive continuing medical education programs to fill those gaps, thereby facilitating better clinical care.

The invention encompasses a method of providing continuing education by connecting a plurality of users in a first community and at least one selected expert in the first community via a network so that each has access to educational material related to at least one pre-selected educational topic, facilitating interactive communication of each educational topic among and between the users and the expert, wherein the interactive communication is later available for subsequent assessment to evaluate a need to modify the educational material for subsequent education.

The invention also encompasses a system for providing continuing education that includes a processing system configured and adapted to communicate with a plurality of computers, wherein the processing system is arranged to accept input from: a plurality of users in a first community and a selected expert in the first community connected via a network; at least one educational topic communicated interactively among and between the plurality of users and the expert; and wherein the processing system is arranged to provide output of the users and the expert for assessment of each educational topic.

The invention also encompasses an article of manufacture that includes a computer readable medium and a data structure stored thereon adapted and configured to receive and transmit signals, wherein the data structure comprises a computer readable system configured and adapted to provide an educational model that includes connecting a plurality of users and a selected expert in a first community via a network so that each has access to educational material related to at least one pre-selected educational topic, facilitating interactive communication of each educational topic among and between the users and the expert, assessing the value of the interactive communication related to each educational topic, adapting the educational material to account for any new information in the interactive communication, and distributing the adapted educational material at least to subsequent users.

The invention further encompasses a system for providing continuing education that includes a means for connecting a plurality of users and a selected expert in the first community via a network so that each has access to educational material related to at least one pre-selected educational topic, a means for facilitating interactive communication of each educational topic among and between the users and the expert, a means for assessing the value of the educational material, a means for adapting the educational material, and a means for distributing the adapted educational material to at least a second community.

The invention also encompasses a method of providing continuing education by connecting at least two users in a first community and at least one selected expert in the first community via a network so that each has access to educational material related to at least one pre-selected educational topic, facilitating interactive communication of each educational topic among and between the users and the expert, assessing the value of the interactive communication of each educational topic to determine a course of action for the educational material, and adapting the educational material to facilitate further continuing education.

Any of the embodiments illustrated above and below stand independently or features may be combined to achieve preferred embodiments. Additional advantages and embodiments of the invention will also become more apparent to those of ordinary skill in the art upon review of the teachings of the present application.

### BRIEF DESCRIPTION OF THE DRAWINGS

Further features and advantages of the invention can be ascertained from the following detailed description that is provided in connection with the drawing(s) described below:

FIG. 1 illustrates an exemplary system and method of the present invention, in accordance with one embodiment of the present invention;

FIG. 2 illustrates an exemplary system and method of the present invention in which the structure of the communication is shown, in accordance with one embodiment of the present invention;

FIG. 3 illustrates an exemplary system and method of the present invention in which the structure of the development of new educational programs is shown, in accordance with one embodiment of the present invention;

FIG. 4 illustrates an exemplary system and method of the present invention pertaining to the healthcare profession, in accordance with one embodiment of the present invention;

FIG. 5 presents hardware, software or a combination thereof that may be implemented in one or more computer systems or other processing systems to carry out the functionality of the present invention, in accordance with one embodiment of the present invention; and

FIG. 6 presents an exemplary system diagram of various hardware components and other features, in accordance with an embodiment of the present invention.

### DETAILED DESCRIPTION OF THE PREFERRED EMBODIMENTS

The present invention provides systems and methods for providing continuing education programs for professionals, such as healthcare professionals, including connecting a plurality of users with at least one expert in a first community, via a network. The users and expert(s) each have access to educational material related to at least one pre-selected educational topic. Advantageously, the users and the expert(s) interactively communicate regarding each educational topic relevant to the first community, and optionally any user or the expert can select one or more additional educational topics for additional learning or discussion. The user may interact with other users and the expert. After the community network is established and communication regarding educational topic is facilitated between the community members, which collectively encompasses the users and each expert, they engage in interactive communication (also interchangeably known herein as “interaction,” “dialogue,” or “discussion”) related to each educational topic. Typically, this will occur with reference to the associated educational material.

Further, the interactive communication may be optionally but preferably be assessed to determine its value (e.g., educational value and clinical value) to further continuing education. The interactive communication on educational topics (which are interchangeably referred to herein as “issues”) of value is then used to modify or otherwise adapt the educational material for subsequent use. Preferably, the educational material is distributed to at least a second community, preferably within the same profession and sharing at least one area of interest or overlapping issues with the first community.

Terms such as “user,” “student,” “pupil,” and “clinician,” as used herein, should be understood to mean any professional participant in, or user of, such continuing education programs, systems, or methods. Healthcare users include physicians, nurses, pharmacists, physicians' assistants, nurse practitioners, researchers, physical therapists, and healthcare executives, for example.

As referred to herein, the term “expert” is meant to encompass a knowledgeable person in the field related to the educational topic rather than a mere functionary. Thus, “expert” should be understood to include “teacher,” “leader,” “faculty member,” “moderator,” or “authority” but not to include a mere functionary such as a webmaster, chat room coordinator, or the like. The quoted terms above related to “expert” are used interchangeably herein. Preferably, an “expert,” as used herein, refers to a recognized expert in the community and is knowledgeable with issues relevant to the community, as well as possibly being a person who has published one or more education-related documents, e.g., in a professional journal or textbook, or all of the above. Typically, the expert's knowledge will include some understanding of new issues not necessarily present in conventional case books or text books or other printed publications. In some variations, experts have obtained professional qualifications identifying their level and skill in the art, preferably with qualifications including recognition of a teaching ability. The expert is generally responsible for providing guidance to the users, answering any direct questions put forth by the users, and moderating the communication between the users, for instance. The expert may also preferably lead the discussion, or delegate or designate one or more users to do so for an entire educational topic, or a portion thereof, as an additional learning technique.

As used herein, a “community” encompasses a subset of the profession, either as a specialty area of the profession or as a common area of interest between the community members, who may be trained or working in any discipline related to the profession, or desire to become affiliated with such discipline, and related to that area of interest. For example, an influenza prevention community may be comprised of healthcare professionals in infectious disease, public health, and hospital administration, for example, but not professionals primarily involved in cardiology or orthopedic surgery, for example.

Generally, continuing education programs are coordinated or provided by an educational provider. The provider is preferably licensed, certified, and/or authorized to provide continuing education to professionals. The provider may also facilitate continuing education in the field by: coordinating pre-selected educational topics for a particular community to facilitate formation of one or more communities; licensing, listing qualifications for, or selecting a suitable roster of, experts in the field; arranging for one or more experts to be associated with one or more particular educational topics or communities; or any combination thereof.

The education program of the present invention is provided through a network, either telephonic or computer-based, preferably computer-based. A “community network” encompasses the network on which a particular community can communicate. Preferably the educational provider establishes and/or operates a plurality of community networks, or coordinates the operation through a third party. The third party need not have any knowledge of the educational content, but simply operates the network to permit the users and experts to form the community. It is also within the scope of the present invention to provide the system and methods of the present invention in live, in-person programs. Preferably, however, at least one of the users, expert, and educational provide is remote; more preferably, at least one of the users and the expert are remote from each other. In one embodiment, each of the users and the expert are all in different remote locations.

Preferably, the present invention includes a computer or other suitable processing system with application software and a communication network, such as the Internet (particularly the World Wide Web) or a local area network (LAN). In some variations, the network extends to terminals that allow community members to interact in a delayed, or more preferably real-time, format. By “real-time” is preferably meant there is no noticeable or deliberately induced time delay, and that interactive communication will occur as reasonably rapidly as the network will permit. The network may be provided by manual or automated systems, including servers, for example.

The present invention, in one embodiment, provides a graphical user interface (GUI) that allows the community members navigate the network and to participate in the continuing education. Community members may communicate through written communication, verbal communication, and preferably through both. More preferably, communication occurs through audio/video aided by the use of audio and visual applications and hardware generally known or available to those of ordinary skill in the art. Preferably, the educational material is provided in written format, e.g., through an email or common downloadable format (e.g., PDF), and preferably during the interactive discussion between and among the users and expert. In another embodiment, the relevant educational material associated with any pre-selected educational topic(s) is provided in advance of the interactive discussion.

The duration and frequency of an education program for a community is variable according to the needs of the community, continuing education requirements, and/or the discretion of the community members and/or educational provider. In some variations, the duration and frequency is correlated to the amount of continuing education credit awarded to the user. The community can be offered, e.g., weekly, bimonthly, monthly, quarterly, semi-annually, or annually, and special communities can be arranged interstitially if necessary or desired.

The communication may be in any format conducive to learning, as would be generally available to those of ordinary skill in the art. In some variations, educational topic(s) to be discussed in the community network are prepared by the educational provider. In related variations, the educational provider is given access to the community discussion, and can introduce topics in real-time. In other variations, the users select and introduce the educational topic(s), and one or more expert can volunteer or otherwise sign up to lead a community; or the educational provider can select and invite one or more experts to do so. In yet other variations, the expert selects and introduces the educational topic(s) in the community network. In still other variations, topics are selected and introduced by a combination thereof. Preferably, at least one educational topic is pre-selected before the community forms to help ensure that a suitable expert and/or interested users are available.

The communication is preferably in the form of a conversational dialogue. In some embodiments, portions of the communications in the community network are, for example, in the form of a question and answer format, a lecture-style presentation by the expert, a debate, user presentation, a case study, a problem-solving format, or any combination thereof. Preferably, users can interact with other users and the expert at any time during the continuing education program. The communication could also be partially or entirely written, e.g., in a question and answer format, user presentation, or debate. The educational material preferably includes a written component or is preferably entirely written.

For example, users in a medical education community may be permitted to discuss the topic of practices in patient care, which is selected and introduced by a first user. Users share experiences with one another. After a certain amount of time, the expert in the community provides authoritative guidance on the best clinical practices for determining the scope or duration of patient care.

The continuing education can be further supplemented with a test to determine comprehension, help users self-determine any additional study or education required, or to help an accrediting authority determine if educational credit should be awarded, if the educational provider requires guidance or replacement, or whether the educational materials require modification. This can be achieved by, e.g., posing a plurality of questions separately to each user, each of whom will need to separately answer each question to arrive at a score or summary of comprehension of the educational material and educational topics covered in the community based on the difficulty and number of correct answers by each user.

Preferably, the users of the first community and the expert are members of the same profession. In another embodiment, the first community is a subset of the second community. While the continuing education may relate to any desired field, it preferably relates to a professional field, e.g., legal profession, healthcare profession, or business profession. More preferably, the continuing education relates to the healthcare profession. In an exemplary embodiment, the continuing education is medical education. The educational topics are preferably associated with the type of continuing education, so for example a legal professional community may have an educational topic about the rule against perpetuities, the complexities of the Internal Revenue Code, or the doctrine of patent claim differentiation, while a healthcare professional community may have a topic related to clinical issues, diagnostic issues, forensic issues, pharmaceutical issues, or the like.

The assessment process is a preferred method of determining the presence and extent of any gaps in the knowledge of the profession among its practicing professionals. It provides a systematic and comprehensive approach to determining these gaps, and improves on traditional methods of collecting this information, such as literature searches, attending professional conferences , and/or simply polling peers for anecdotal evidence because it involves the interactive discussion between and among professionals and an expert. The assessment process, which is preferably implemented and encompasses the review of the interactive communications of a community or of a particular educational or every educational topic of a community, can be conducted anytime after the network for that community is established and some communication has taken place. Thus, the assessment process may be conducted during and/or after the education program. In some embodiments, the assessment process is conducted concurrently while the community is engaged in communication, e.g., by the expert or by a second, independent expert that does not participate. Accordingly, assessors are provided with real-time access to a community discussion. Preferably, the assessors are only provided with monitoring capabilities and not with input access to interact with the community discussion.

The assessment process may also be delayed. For example, the assessment process may take place after the conclusion of the community education program, or beginning subsequent to the initial discussions but before the conclusion. When the assessment is delayed, the assessors can review the community education program through transcripts, video/audio recording, for example. In varying embodiments, the assessment of the educational topics discussed in the community is conducted within a one year of the conclusion of the community, preferably within 6 months, more preferably within 3 months, and even more preferably within two weeks. More rapid assessment tends to permit more rapid modification of educational material, if needed, and more rapid dissemination or distribution to others in the community, so long as sufficient time passes for a thorough assessment.

The assessment process is premised on selecting the information and knowledge in the community discussion having value. As used herein, the term “value” encompasses information or knowledge that is useful to professionals in the profession or could benefit the profession. Value may be derived from the content, scope, and extent of the discussion between and among the users and the expert. For instance, recognition of a persistent problem—or failure to recognize a persistent problem—among a community is of value, in some variations. Moreover, solutions proffered—or not proffered—by community members to a particular problem may also be of value. In most embodiments, value is determined by whether the information and knowledge advances the community and/or profession in some manner, as determined by the educational provider, e.g., a second expert hired by the provider. In other embodiments, value is determined by the assessors, such as an expert that is independent of the education provider or, for example, working under the auspices of an accreditation authority or a university.

For example, a community focused on patient care for patients with chronic illness may discuss information concerning clinical methods of care as an educational topic. The topic may have value if, for example, the discussion is related to patient care in other settings, such as patients with acute illnesses or patients in long term medical facilities.

The adaptation process is generally related to translating the communication of the educational topic in the first community to medium that can be shared with a second community or even provided to the first community for further study or consideration. The result of the adaptation process includes modifying as needed any educational material, for example, in the form of presentations, examples, pictures, software, computer accessible programs, audio/visual recordings, lessons, printed handouts, publications, case-studies, practice problems, tests, discussions, or any combination thereof. In some variations, the educational material is included in any tangible medium that may be shared with at least a second community. The tangible medium can, e.g., be a computer-accessible program, printed materials, or both. In accordance with the present invention, the adaptation process is completed within 1 year, preferably 9 months, more preferably 6 months, and even more preferably 3 months, of selecting the topic of value. In a more preferred embodiment, the adaptation can occur within about 1 month following the conclusion of the educational topic. It can also be completed more rapidly, such as within about 1 to 20 days following the assessment.

In preferred embodiments, the assessment and adaptation of the communications between community members is conducted by the educational provider, such as one or more of its employees, designatees, and/or agents, including faculty and community experts.

Distribution encompasses providing the adapted educational material to at least a second community. A used herein, a “first community” is a generic community that distinguishable from a “second community” or “other communities,” which are directed to areas of the profession generally different from the first community. In some variations, the second community either encompasses the first community, the second community is a subset of the first community, or preferably, the second community is all together a separate community from the first community under the same profession. The second community may include the same expert from the first community, but with completely different users.

Generally, the distribution of the educational materials is either physical (e.g., handing out person-to-person), or preferably, virtual over a network, which may be the same or different from that used for each community. For example, in the healthcare field, the educational provider may provide, over a computer-based network, guidance publications on patient care, which were developed from a first community discussing clinical issues of influenza, to a second community focused on clinical issues of bacterial infections.

It is recommended that the education material reach the second community within a generally short time frame to maximize the benefits to the second community. Accordingly, the processes of assessment, adaptation, and distribution should be completed within 1 year of the initial communication of the topic in the community. Preferably, the processes should be completed within 9 months of the communication of the topic in the community. More preferably, the processes should be completed within 6 months of the communication of the topic in the community. In a few most preferred embodiments, the processes should be completed within 3 months, 2 months, 1 month, or even 2 weeks, of the conclusion of the interactive communication of the topic in the first community.

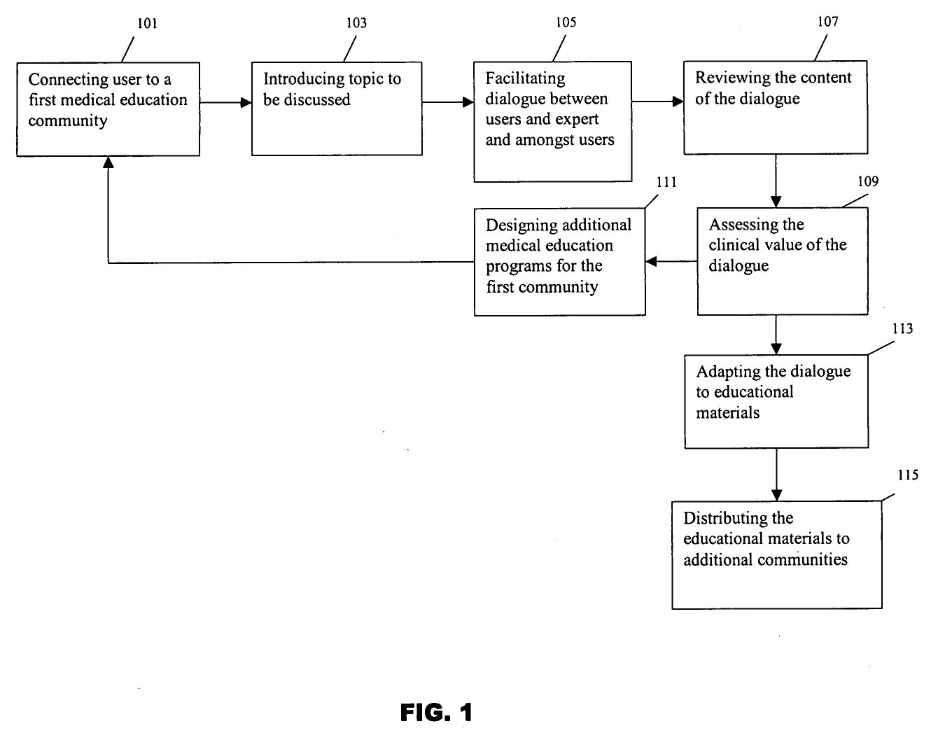

In certain embodiments of the present invention, as illustrated by FIG. 1, at least one user, preferably a plurality of users, is connected to a first medical community 101, where a educational topic is introduced and contemplated, and preferably discussed, by the community 103. The system facilitates interaction between the user and the expert and amongst the users 105. The community includes at least one designated expert, who is accessible by the user(s) and is able, for example, to monitor any discussion, respond to user queries, and provide advice at will or as necessary. In some variations, the system limits or expands the scope of interaction by the expert.

The leader may be chosen by the educational provider to provide expert analysis. Preferably, the leader is recognized in the community or presented to the community as an expert. More preferably, the leader possesses the education, accomplishments, and/or experience predetermined by the educational provider or an independent third party to lead a community.

During (or after) the continuing education program, the educational provider, or agent thereof, reviews the content of the community discussion 107 and assesses the value of the dialogue 109. The educational provider may design additional continuing education programs for the first community 111. The additional continuing education program begins by connecting a plurality of users to a community via a network 101.

The valuable information derived from the first community may also be adapted to educational materials for a second community 113. After development, these educational materials may be distributed to the second community 115, which may further discuss these materials via a network of the second community.

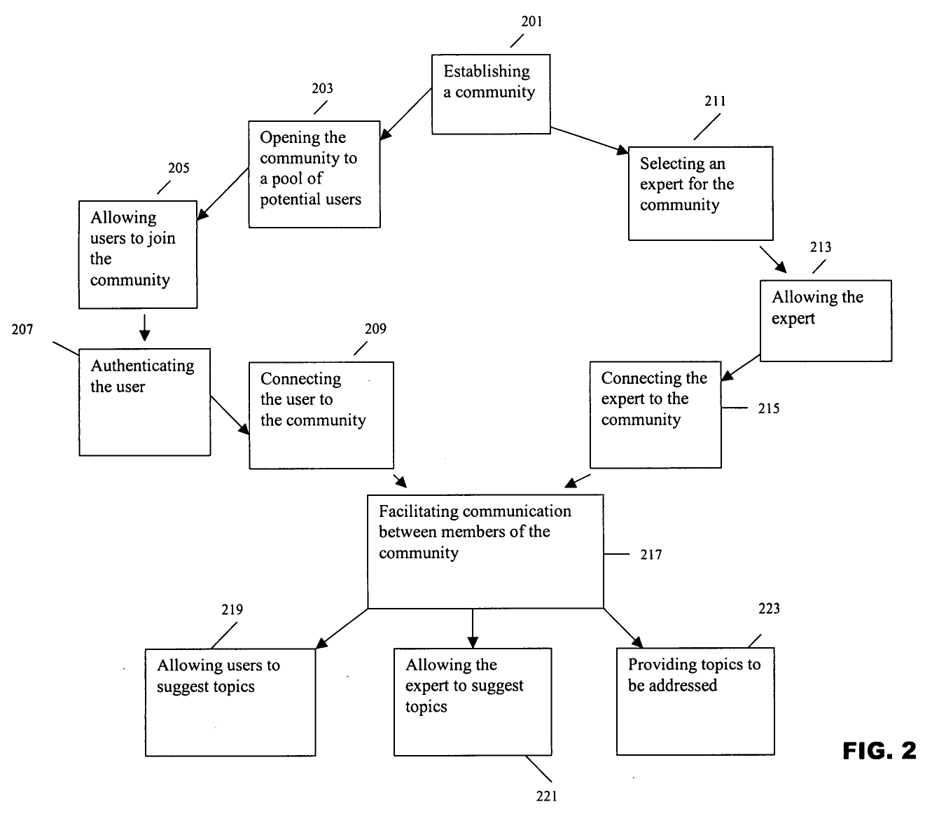

FIG. 2 provides an exemplary illustration of the establishment of a community 201, which is comprised of user participation and expert participation. With respect to users, once a community is established 201, the community is opened to a pool of potential users 203. In some variations, the pool is comprised of any person in the profession. In other variations, the pool is restricted to any person meeting the qualifications of the pool, as determined by the educational provider, professional continuing education certification or licensing board, or third party. Qualified users are permitted to access the community 205. In some variations, an authentication/verification of registration is required to certify the identity of the user 207. Authentication/verification processes as are compatible with the present invention are generally known to those of ordinary skill in the art. Upon authentication/verification, which may require, e.g., prepayment or a check to determine the user has not been restricted from access by the educational provider, the user is connected to the community 209.

An expert is selected to participate in the community 211. In preferred variations, the expert is selected by the educational provider. Subject to an optional authentication/verification procedure, as discussed above, the expert is allowed to join the community 213 and connect to community members through the network 215.

When at least one user and an expert is present, the educational program may commence and communication between the community members and expert is facilitated 217. In certain embodiments, users suggest the educational topic 219. In other embodiments, the expert suggests the educational topics 221. In yet other embodiments, the educational provider and/or host of the network provides the topics to be discussed in the community 223. In some embodiments, the continuing education certification and licensing board approves of the topic for continuing educational credit.

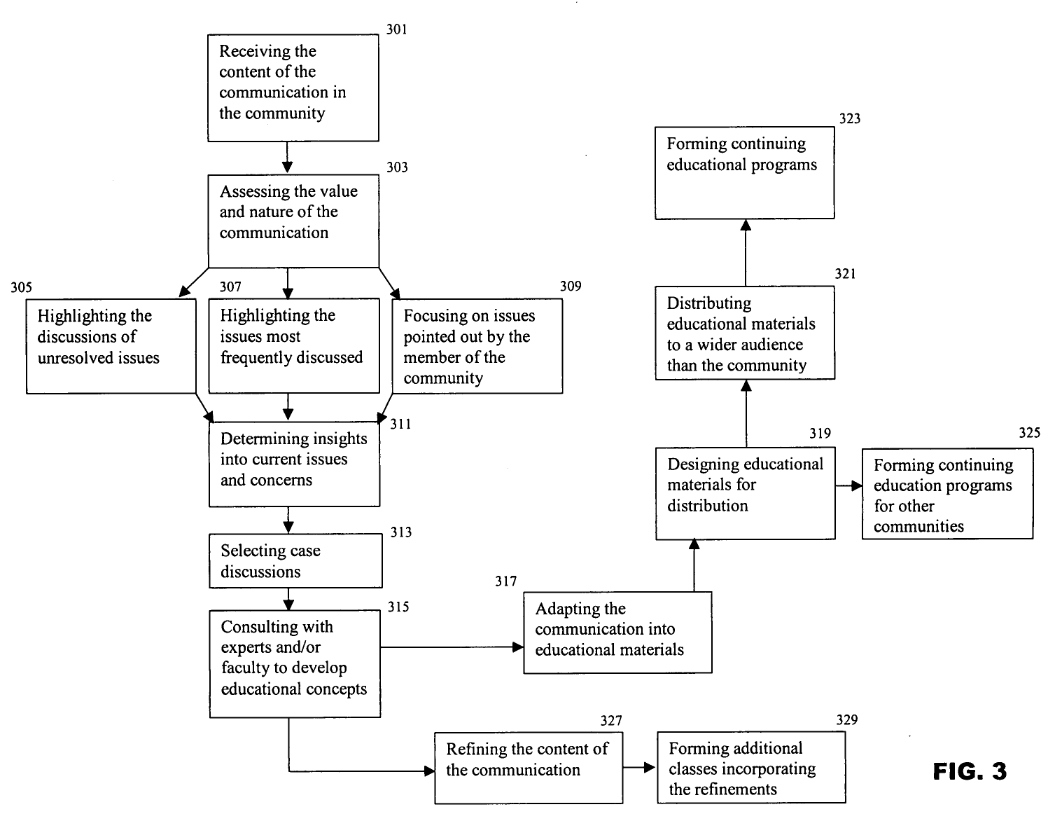

The review of community discussions and the development of subsequent educational materials is further illustrated in FIG. 3. A community discussion via a network may be reviewed in real-time as the community discussion occurs, or after the conclusion of the community discussion 301.

In some variations, the review and assessment of the first community discussion are conducted by the educational provider. Preferably, the review and assessment are conducted by professionals employed by the educational providers, such as faculty members and experts of other communities, for example. More preferably, the review and assessment are conducted by one or more professionals in the same profession as the community members.

The educational topic is assessed to determine whether it has value for other audiences (e.g., larger audiences). In some embodiments, value is found in discussions of unresolved issues in the community 305, for example. In other embodiments, value is determined by the most frequently discussed issue 307, for example. In yet other embodiments, the topics of value are marked by the community 309, for example.

The selection of value-based discussions facilitates the determination of current issues and concerns in the community 311, which form the basis of case studies and further discussions 313 for the first community, or a portion thereof, or for second or subsequent communities. In some embodiments, one or more experts, faculty members, or other parties with an interest in developing continuing educational programs help develop educational concepts 315. In some instances, the educational materials are focused on refining the content of the discussion of the first community 327. Moreover, additional educational programs may be formed for the first community to address the refined content 329.

The educational concepts may also be adapted to produce educational materials 317. Once the educational materials are designed 319, they may be distributed to wider audiences 321, such as other communities sharing an area of overlapping interest or concern with the first community. Continuing education programs may be formed for other communities with or without the development of distributable materials 323 and 325.

### EXAMPLES

### Example 1

### Continuing Medical Education

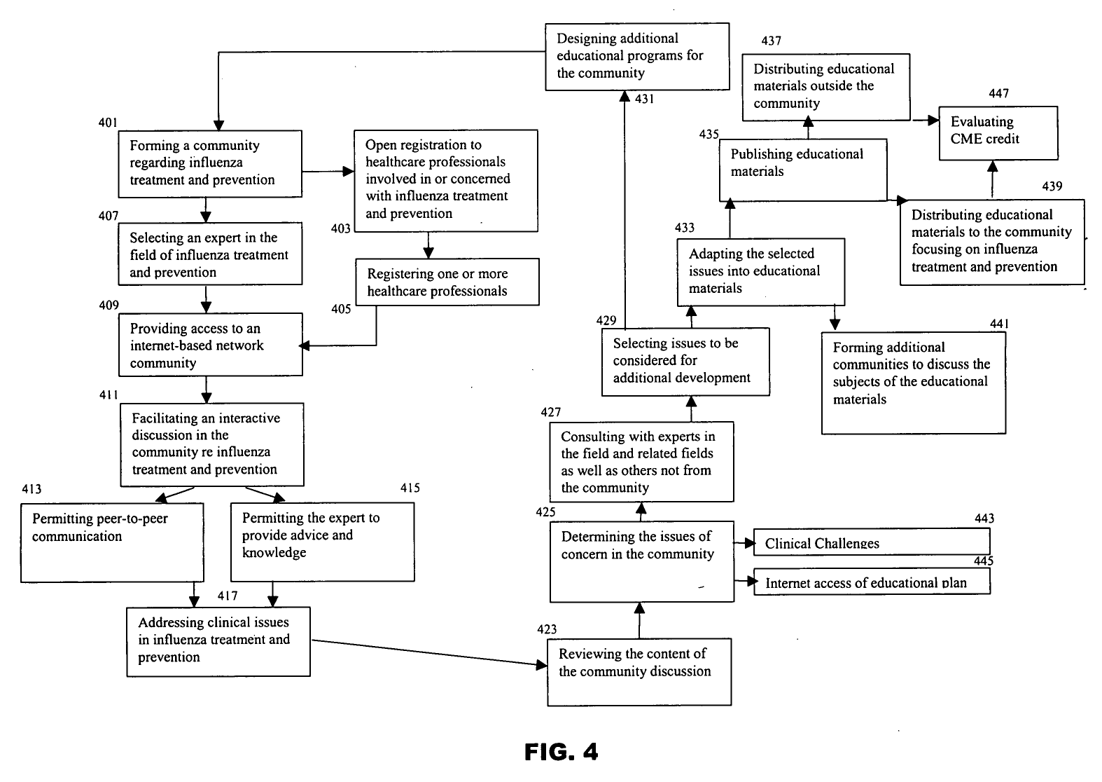

FIG. 4 provides an exemplary illustration of the system and methods of the present invention as it applies to communities in the healthcare industry. A community is formed regarding influenza treatment and prevention 401, and registration is opened to healthcare professionals generally involved in, or concerned with, influenza treatment and prevention 403. Users are registered for the community continuing education program 405. In association with user registration, e.g., concurrently, an expert is selected to moderate the community of influenza treatment and prevention 407. Both the users and the expert(s) (i.e., collectively the community members) are provided with access to an Internet-based network 409 that allows them to connect and communicate, preferably in real-time.

With the commencement of the community network, the community members can engage in an interactive discussion regarding influenza treatment and prevention 411. The healthcare users are permitted to communicate with one another 413, and the expert is permitted to provide advice and knowledge to the users 415. In some variations, the community members discuss clinical issues in influenza treatment and prevention.

Observers of the community discussion review the content of the community discussion 423, determining the issues of value (e.g., issues of concern among clinicians or other healthcare professional users) in the community 425. The observer(s) may be the expert, one or more independent parties in the same field, or simply one or more healthcare professionals with knowledge of the topics, or any combination. For example, valued educational topics may include clinical challenges 443 and areas insufficiently covered by the continuing education program (i.e., areas of interest not addressed in the CME program) 445. Experts in related and unrelated fields, for example, consult 427 and select issues for additional development 429. In some instances, continuing education programs for the community of influenza treatment and prevention are designed 431 and additional continuing education programs are formed 401. In preferred embodiments, the selected issues are adapted to educational materials 433. In some variations, the strategy and development of the educational materials are the subject of other communities 441.

Finished educational materials may be published 435 and distributed to one or more second communities 437, such as a community concerning HIV treatment and prevention, for example, or to the first community concerning influenza treatment and prevention 439. Optionally, CME credit may be evaluated and awarded 447 thereafter.

### Example Processing System Components and Functionality

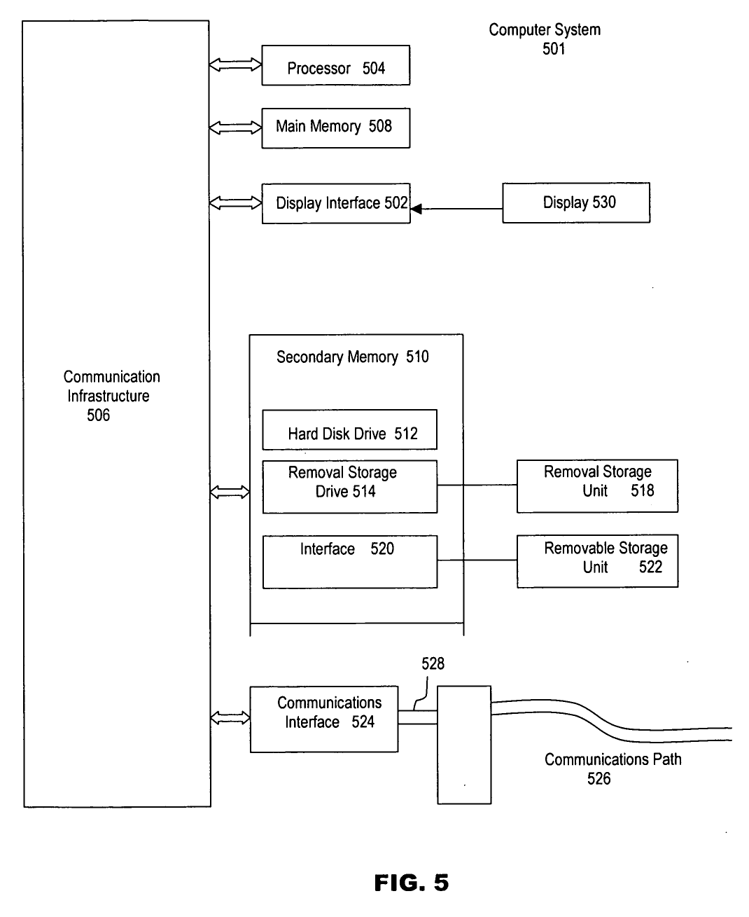

The present invention may be implemented using hardware, software, or a combination thereof and may be implemented in one or more computer systems or other processing systems. In one embodiment, the invention is directed toward one or more computer systems capable of carrying out the functionality described herein. An example of such a computer system is shown in FIG. 5.

Computer system 500 includes one or more processors, such as processor 504. The processor 504 is connected to a communication infrastructure 506 (e.g., a communications bus, cross-over bar, or network). Various software embodiments are described in terms of this exemplary computer system. After reading this description, it will become apparent to a person of ordinary skill in the art how to implement the invention using any other suitable available computer system(s) and/or architecture(s).

Computer system 500 can include a display interface 502 that forwards graphics, text, and other data from the communication infrastructure 506 (or from a frame buffer not shown) for display on the display unit 530. Computer system 500 also includes a main memory 508, preferably random access memory (RAM), and may also include a secondary memory 510. The secondary memory 510 may include, for example, a hard disk drive 512 and/or a removable storage drive 514, representing, e.g., a floppy disk drive, a magnetic tape drive, an optical disk drive, a flash card, a memory stick, a thumb drive, personal digital assistant (“PDA”), etc. By “PDA” is meant, e.g., a Blackberry® wireless device from RIM of Canada or a Palm®, Treo®, Zire® or related device from Palm, Inc. The removable storage drive 514 reads from and/or writes to a removable storage unit 518 in a well-known manner. Removable storage unit 518, represents a floppy disk, magnetic tape, optical disk, a flash card, a memory stick, a thumb drive, personal digital assistant (“PDA”), etc., which is read by and written to removable storage drive 514. As will be appreciated, the removable storage unit 518 includes a computer usable storage medium having stored therein computer software and/or data.

In alternative embodiments, secondary memory 510 may include other similar devices for allowing computer programs or other instructions to be loaded into computer system 500. Such devices may include, for example, a removable storage unit 522 and an interface 520. Examples of such may include a program cartridge and cartridge interface (such as that found in video game devices), a removable memory chip (such as an erasable programmable read only memory (EPROM), or programmable read only memory (PROM)) and associated socket, and other removable storage units 522 and interfaces 520, which allow software and data to be transferred from the removable storage unit 522 to computer system 500, as well as any of the removable storage drive or memory noted above.

Computer system 500 may also include a communications interface 524. Communications interface 524 allows software and data to be transferred between computer system 500 and external devices. Examples of communications interface 524 may include a modem, a network interface (such as an Ethernet card), a communications port, a Personal Computer Memory Card International Association (PCMCIA) slot and card, etc. Software and data transferred via communications interface 524 are in the form of signals 528, which may be electronic, electromagnetic, optical or other signals capable of being received by communications interface 524. These signals 528 are provided to communications interface 524 via a communications path (e.g., channel) 526. This path 526 carries signals 528 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 514, a hard disk installed in hard disk drive 512, and signals 528. These computer program products provide software to the computer system 500. The invention is directed to such computer program products.

Computer programs (also referred to as computer control logic) are stored in main memory 508 and/or secondary memory 510. Computer programs may also be received via communications interface 524. Such computer programs, when executed, enable the computer system 500 to perform the features of the present invention, as discussed herein. In particular, the computer programs, when executed, enable the processor 504 to perform the features of the present invention. Accordingly, such computer programs represent controllers of the computer system 500.

In an embodiment where the invention is implemented using software, the software may be stored in a computer program product and loaded into computer system 500 using removable storage drive 514, hard drive 512, or communications interface 524. The control logic (software), when executed by the processor 504, causes the processor 504 to perform the functions of the invention as described herein. In another embodiment, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

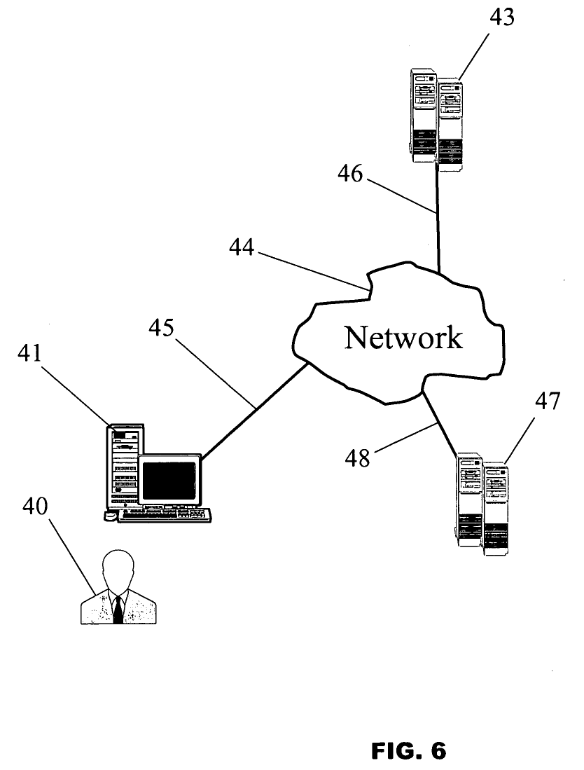

As shown in FIG. 6, in an embodiment of the present invention, the multimedia application operates, for example, on a network. A user 40, such as an applicant or application processor inputs information, via a terminal 41, such as a personal computer (PC), minicomputer, mainframe computer, microcomputer, telephone device, personal digital assistant (PDA), or other device having a processor and input capability.

As further shown in FIG. 6, in one embodiment, the terminal 41 is coupled to a server 43, such as a PC, minicomputer, mainframe computer, microcomputer, or other device having a processor and a repository for data or connection to a repository for maintained data, via a network 44, such as the Internet, via couplings 45, 46, such as wired, wireless, or fiber optic connections.

Although the above problems have been discussed in the context of continuing medical education of health care providers, in order to improve quality of health care, these same problems are present in other areas where proper or current education is fundamental in improving quality of service. For example, such problems are present in information technology, airline pilots, mechanics, lawyers, new employee training, and other areas. The present invention, however, is not limited to any particular profession, occupation, or type of service.

Although preferred embodiments of the invention have been described in the foregoing description, it will be understood that the invention is not limited to the specific embodiments disclosed herein but is capable of numerous modifications by one of ordinary skill in the art. It will be understood that the components used and technological details may be slightly different or modified from the descriptions herein without departing from the methods and devices disclosed and taught by the present invention. Many variations and modifications will be apparent to those of ordinary skill in the art.

What is claimed is:

1. A method of providing continuing education which comprises:
connecting a plurality of users in a first community and at least one selected expert in the first community via a network so that each has access to educational material related to at least one pre-selected educational topic;
facilitating interactive communication of each educational topic among and between the users and the expert,
wherein the interactive communication is later available for subsequent assessment to evaluate a need to modify the educational material for subsequent education.

2. The method of claim 1, wherein the communicating is real time.

3. The method of claim 1, wherein the network is established by an educational provider that is remote from at least one of the users or the expert in the first community.

4. The method of claim 1, wherein the connecting is via a telephonic or a computer network.

5. The method of claim 5, wherein the connecting is over the computer network.

6. The method claim 1, wherein the facilitating comprises the expert moderating the interactive communication of the at least one educational topic.

7. The method of claim 1, wherein the educational topic is presented by the expert.

8. The method claim 1, wherein the user poses one or more questions about each educational topic to one or more other users or the expert.

9. The method of claim 1, wherein the educational material is published in a case study format.

10. The method of claim 1, further comprising distributing the educational material in a tangible medium.

11. The method of claim 1, which further comprises posing to each user a plurality of questions related to the educational material and assessing a score based on the number of correct answers by each user.

12. The method of claim 1, wherein the users of the first community and the expert are members of the same profession.

13. The method of claim 1, wherein the first community is a subset of the second community.

14. The method of claim 1, wherein the continuing education relates to the healthcare profession.

15. The method of claim 14, wherein the continuing education is medical education.

16. The method of claim 15, wherein the at least one educational topic relates to clinical issues.

17. The method of claim 1, which further comprises: assessing the interactive communication of the at least one educational topic; and
then distributing one or more additional educational topics for the first community.

18. The method of claim 1, wherein the users and expert are each a healthcare professional that includes a physician, nurse, pharmacist, physicians' assistant, nurse practitioner, researcher, physical therapist, healthcare executive, or a combination thereof.

19. A system for providing continuing education comprising:
a processing system configured and adapted to communicate with a plurality of computers, wherein the processing system is arranged to accept input from:
a plurality of users in a first community and a selected expert in the first community connected via a network;
at least one educational topic communicated interactively among and between the plurality of users and the expert; and
wherein the processing system is arranged to provide output of the users and the expert for assessment of each educational topic.

20. An article of manufacture comprising:
a computer readable medium; and a data structure stored thereon adapted and configured to receive and transmit signals, wherein the data structure comprises a computer readable system configured and adapted to provide an educational model which comprises:
connecting a plurality of users and a selected expert in a first community via a network so that each has access to educational material related to at least one pre-selected educational topic;
facilitating interactive communication of each educational topic among and between the users and the expert;
assessing the value of the interactive communication related to each educational topic;
adapting the educational material to account for any new information in the interactive communication; and
distributing the adapted educational material at least to subsequent users.

21. A system for providing continuing education which comprises:
a means for connecting a plurality of users and a selected expert in the first community via a network so that each has access to educational material related to at least one pre-selected educational topic;
a means for facilitating interactive communication of each educational topic among and between the users and the expert;
a means for assessing the value of the educational material;
a means for adapting the educational material; and
a means for distributing the adapted educational material to at least a second community.

22. A method of providing continuing education which comprises:
connecting at least two users in a first community and at least one selected expert in the first community via a network so that each has access to educational material related to at least one pre-selected educational topic;
facilitating interactive communication of each educational topic among and between the users and the expert;
assessing the value of the interactive communication of each educational topic to determine a course of action for the educational material; and
adapting the educational material to facilitate further continuing education.

23. The method of claim 22, which further comprises distributing the adapted educational material in association with a subsequent community related to the at least one educational topic.

24. The method of claim 22, which further comprises distributing the adapted educational material to at least a second community related to at least a second, different educational topic.

25. The method of claim 22, wherein the assessing and adapting occur within 6 months of the interactive communication.
